(19) United States
(12) Patent Application Publication
(10) Pub. No.: US 2009/0186304 A1
(43) Pub. Date: Jul. 23, 2009

(54) GRAVITY AND PRESSURE ENHANCED REFLOW PROCESS TO FORM LENS STRUCTURES

(75) Inventor: Saijin Liu, Boise, ID (US)

Correspondence Address: RatnerPrestia, P.O. BOX 980, VALLEY FORGE, PA, 19482, US

(73) Assignee: MICRON TECHNOLOGY, INC., Boise, ID (US)

(21) Appl. No.: 12/017,458

(22) Filed: Jan. 22, 2008

(51) Int. Cl. B29D 11/00

(52) U.S. Cl. 430/321; 264/1.27

(57) ABSTRACT

A lens structure and methods of forming the lens structure are disclosed. The method includes attaching a lens block to a substrate such that gravitational force acts to push the lens block against the substrate. The substrate is positioned such that gravitational force acts to pull the lens block from the substrate. The lens block is then heated such that gravity and surface tension of the block forms the lens structure.

### FIELD OF THE INVENTION

The present invention relates to lens structures and methods for forming lenses.

### BACKGROUND OF THE INVENTION

Reflow processes are extensively used method to form lens structures. These processes typically include heating lens materials to their liquid transition temperatures, so the surface tension of the heated material will cause the material to form into a spherical shape. The material is then hardened to maintain the shape of the lens.

A reflow process may be suitable for forming micro-lenses, but may not be suitable for forming larger lenses, such as millimeter or larger sized lenses. When forming larger lens structures using this process, gravitational force acting against the heated material overcomes the surface tension of the material, thereby collapsing the spherical shape before the material hardens.

Another approach to forming larger sized lens involves imprinting, whereby a “stamp” is used to push heated material to form the lens shape. The “stamp” itself is formed by a complex process and has the “reversed” spherical lens shape. Thus, when the stamp pushes against relative soft materials, such as heated glass, it can transfer its “reversed” lens shape into the glass to form the lens. The imprinting process is expensive, however, because stamps have fixed sizes and more than one stamp may be required to manufacture different lens structures. Due to the high costs associated with imprinting, and size limitations with standard reflow processes, a cost-effective and configurable manufacturing process is desirable.

### BRIEF DESCRIPTION OF THE DRAWING

FIGS. 1A-1C are cross-sectional views of a substrate and lens material which are useful for describing the formation of an example lens structure;

FIGS. 2A-2C are cross-sectional views of a substrate and lens material which are useful for describing the formation of an example lens structure;

FIGS. 3A-3C are cross-sectional views of a substrate and lens material which are useful for describing the formation of an example lens structure; and

FIGS. 4A-4B are cross-sectional views of a substrate and lens material which are useful for describing the formation of an example lens structure.

### DETAILED DESCRIPTION OF THE INVENTION

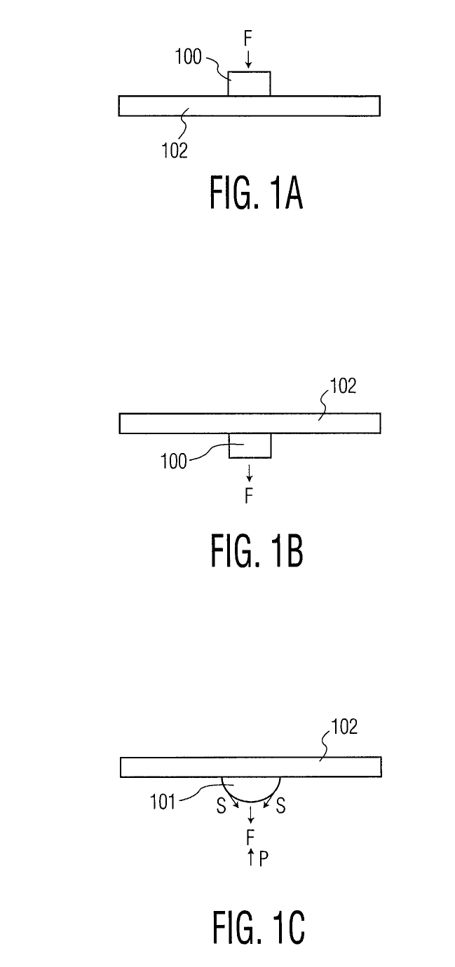

Referring now to the individual figures in detail, FIGS. 1A-1C depict a series of steps for forming a lens structure 101. According to an embodiment, lens block 100 is first attached to substrate 102 using conventional manufacturing techniques such that gravitational force F acts to push the lens block 100 against the substrate 102. For example, lens block 100 may be formed on substrate 102 by photolithography or inkjet printing such that lens block 100 is securely attached on substrate 102. Lens block 100 is held on substrate 102 by surface adhesion which is usually stronger than gravity. Lens block 100 may have various dimensions depending on the type of lens to be manufactured. To form a micro-lens, for example, lens block 100 may be several microns in dimension (e.g. between 5 microns and 100 microns). To form a mini-lens, lens block 101 may be several millimeters in dimension. For example, lens block 101 may range from 0.1 mm up to 3 mm, or even as much as several tens of millimeters. According to an embodiment, lens block 100 may be made of any solid or liquid material that possesses radiation such as polymers, photoresists, or silicon based materials. Other compounds may be added to the lens material to create lens blocks 100 which selectively block or pass radiation at selected wavelengths.

Substrate 102, to which lens block 100 is attached, is generally a flat surface that may be made of various materials such as silicon nitride, silicon oxide, or titanium oxide. In other embodiments, substrate materials including silica based substrates, such as glass, quartz, silicon or polysilicon may be used. It is contemplated that substrate 102 can be made of any material that possesses radiation at some wavelength and remains a solid to withstand high temperatures during the heating process that turns lens block 100 into a liquid. For example, substrate 102 may have a temperature threshold of about 450° C. or greater.

According to an embodiment, shown in FIG. 1B, substrate 102 may be positioned such that gravitational force F acts to pull the lens block 100 from the substrate 102. In this position, lens block 100 may be heated to a temperature that causes reflow. For example, if lens block 100 is formed from JSR MFR401 series materials available from JSR Corporation, these photoreactive compounds and phenolic resin solutions may be heated between a temperature within a range of 150° C. to 300° C. for about 2 to 30 minutes. Thus, as shown in FIG. 1C, transition of lens block 100 to its liquid phase allows surface tension S and gravitational force F assist the formation of lens structure 101. Alternatively, lens block 100 may be attached to substrate 102 as a liquid that is hardened by UV light, epoxy hardener, etc. In an embodiment, the size/shape of lens structure 101 may be controlled by applying a chemical solution to lens block 100 to increase or decrease surface tension S. Types of chemical solutions include JSR Corporation's MCT2021, which are acrylate copolymers, or similar materials. For example, when lens block 100 is positioned such that gravitational force F pulls the lens block 100 away from substrate 102, a surfactant may be applied to decrease surface tension S and create larger sized lens structure 101. Alternatively, an anti-surfactant may be applied to increase surface tension S and create smaller sized lens structures 101. In another embodiment, the size/shape of lens structure 101 may be controlled by adjusting air pressure P acting against the lens structure 101. For example, air pressure P may be adjusted between 0 atm to 3 atm to control the shape of lens structure 101 as it hardens. Lens structure 101 may be hardened, for instance, by cooling, by applying ultraviolet light, or by applying an epoxy hardener to an epoxy resin.

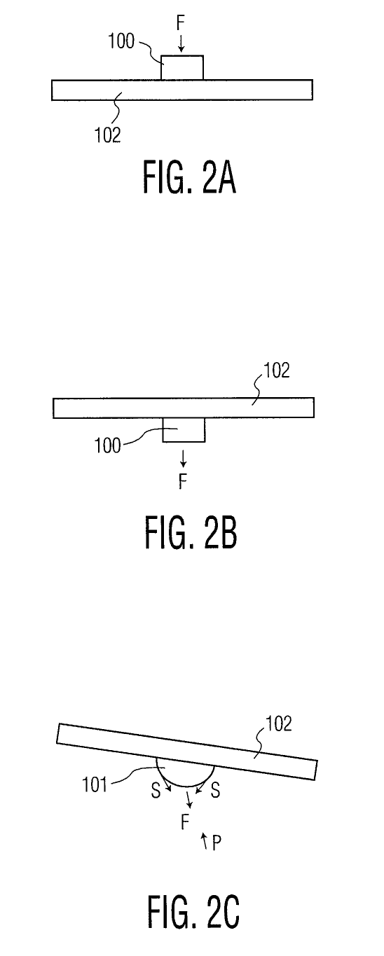

Referring now to FIGS. 2A-2B, as described above, lens block 100 is attached to substrate 102 such that gravitational force F pushes lens block 100 against substrate 102. Substrate 102 is then positioned such that gravitational force F acts to pull lens block 100 away from substrate 102 (e.g. the substrate is inverted). If the material is applied in a liquid state, it may be desirable for the liquid to be sufficiently viscous as to remain separated from adjacent lens blocks when the substrate is inverted. According to an embodiment shown in FIG. 2C, during the heating process, substrate 102 may be rotated at a fixed speed or tilted at an angle so a skewed lens structure 101 is formed as it hardens. As described above, air pressure P may be adjusted to further control the shape of lens structure 101. When the substrate includes multiple lens blocks, the substrate may be rotated at different speeds or tilted at different angles or along different axes as each lens or group of lenses is hardened.

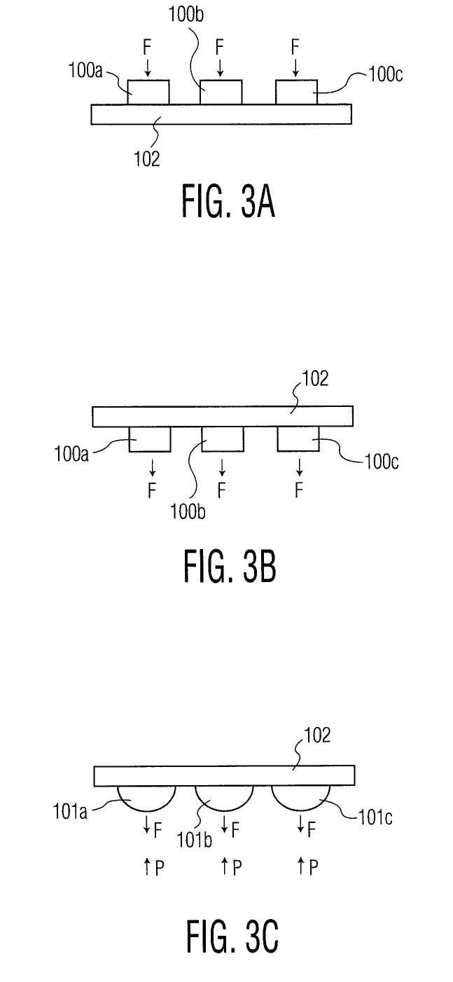

Referring now to FIGS. 3A, according to an embodiment, an array of lens blocks 100a-c may be attached to substrate 102. Lens blocks 100a-c may be formed on substrate 102 according to a predetermined pattern using photolithography or inkjet printing. As illustrated in FIG. 3B, substrate 102 is positioned such that gravitational force F acts to pull each lens block 100a-c away from substrate 102. Each lens block 100a-c may be selectively heated to a temperature that causes reflow. For example, a laser may be used to selectively heat lens block 100a-c to a liquid state. Alternatively, lens block 100a-c may be attached to substrate 102 in a liquid state. According to an embodiment, lens structures 101a-c may be selectively hardened such that lens structures 101a-c may have different sizes and/or shapes on substrate 102. For example, lens structure 101a may be hardened first, and then lens structure 101b, 101c are hardened at a later time so that lens structure 101a has a smaller shape than lens 101b, 101c. In yet another embodiment, substrate 102 may be rotated at respectively different angles while selectively hardening each lens structure 101a-c.

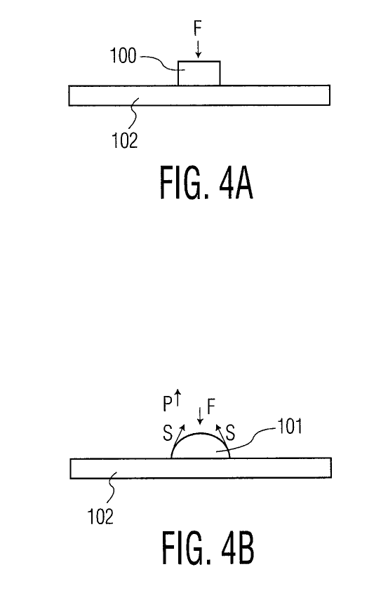

Referring now to FIGS. 4A-4B, lens block 101 may be formed on substrate 102 and then heated to form lens structure 101. According to an embodiment, air pressure P is adjusted, for example, by removing atmosphere in a vacuum so air pressure P opposes gravitation force F. Thus, air pressure P counteracts gravitational force F against lens block 100 so surface tension S of the heated lens material maintains the shape of lens structure 101 as it hardens. Alternatively, an antisurfactant chemical solution may be applied to lens block 101 to increase surface tension S to maintain the spherical shape.

Advantages associated with the processes described herein include lower manufacturing costs compared to other techniques such as imprinting. Furthermore, lens shape may be adjusted by changing parameters such as the size of lens block 100, temperature, and air pressure.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of forming a lens structure comprising the steps of:
attaching a lens block to a substrate;
positioning the substrate such that the gravitational force acts to pull the lens block from the substrate when the lens block is in a liquid state; and
hardening the lens block.

2. The method of claim 1, further comprising heating the lens block such that gravity and surface tension of the block forms the lens structure, wherein the hardening step comprises cooling the lens structure.

3. The method of claim 1, wherein the attaching of the lens block to the substrate comprises attaching the lens block to the substrate such that gravitational force acts to push the lens block against the substrate

4. The method of claim 3, wherein the step of attaching the lens block to the substrate includes depositing a separated portion of a liquid material to the substrate to form the lens block, wherein the hardening step hardens the separated portion of the liquid material.

5. The method of claim 3, wherein:
the step of depositing the separated portion of a liquid material to the substrate includes applying an ultraviolet curable polymer; and
the hardening step includes exposing the separated portions to ultraviolet light.

6. The method of claim 3, wherein:
the step of depositing the separated portion of a liquid material to the substrate includes applying an epoxy resin; and
the hardening step includes applying an epoxy hardener to the separated portions.

7. The method of claim 1, further comprising adjusting atmospheric pressure against the lens block when it is positioned such that gravitational force acts to pull the lens block from the substrate.

8. A method of forming an array of lens structures comprising:
attaching an array of separated liquid portions as an array of respective lens blocks to a substrate such that gravitational force acts to push each lens block against the substrate;
positioning the substrate such that gravitational force acts to pull each lens block from the substrate when the array of lens blocks are in a liquid state;
rotating the substrate while selectively hardening each lens block of the array of lens blocks.

9. The method of claim 8, further comprising adjusting atmospheric pressure against the lens blocks.

10. A method of forming an array of lens structures comprising:
attaching an array of lens blocks to a substrate such that gravitational force acts to push each lens block against the substrate;
positioning the substrate such that gravitational force acts to pull each lens block from the substrate;
heating the blocks such that gravity and surface tension of the blocks forms the array of lens structures; and
tilting the substrate while selectively cooling each lens structure.

11. The method of claim 10, wherein the tilting of the substrate include tilting the substrate by at least one of a different angle or along a different axis while selectively cooling each respective lens structure.

12. The method of claim 10, wherein heating the blocks comprises selectively heating each block to a liquid state.

13. A method of forming a lens structure comprising the steps of:
attaching a lens block to a substrate such that gravitational force acts to push the lens block against the substrate;
heating the block such that surface tension of the lens block opposes the gravitational force against the lens block; and
adjusting air pressure in a direction opposite gravitational force against the lens block.

14. The method of claim 13, further comprising hardening the lens block to form the lens structure.

15. The method of claim 13, further comprising applying a chemical solution to the lens block that increases the surface tension of the block

16. A lens structure having a shape defined by surface tension of the lens structure and gravitational forces pulling a separated portion of a liquid away from a substrate.

17. The lens structure of claim 16, wherein the lens structure is a mini-lens having a dimension between 0.1 mm and 10 mm.

18. The lens structure of claim 16, wherein the lens structure is a micro-lens having a dimension between 5 microns and 100 microns.

19. The lens structure of claim 16, wherein the lens has a shape defined by gravitational forces pulling the separated portion of the liquid away from the substrate at an acute angle.

20. The lens structure of claim 16, wherein the lens has a shape further defined by air pressure greater than atmospheric pressure being applied to the portion of the liquid as the portion of the liquid is hardened.
